(19) United States
(12) Patent Application Publication
(10) Pub. No.: US 2021/0092905 A1
(43) Pub. Date: Apr. 1, 2021

(54) Whole Plant Bucker

(71) Applicant: Thomas Bruggemann, Woodland Hills, CA (US)

(72) Inventor: Thomas Bruggemann, Woodland Hills, CA (US)

(21) Appl. No.: 16/586,808

(22) Filed: Sep. 27, 2019

(51) Int. Cl. A01G 3/00

(52) U.S. Cl. CPC A01G 3/00

(57) ABSTRACT

A whole plant bucker having a bucking member with sides extending from a base plane to a height, a plurality of slot openings formed within the sides such that the slot openings converge to an input opening, and an angle between the sides and the base plane that is greater than zero. The input opening receives the trunk of a whole plant, and the slot openings receive branches of the plant and strip off plant material as the plant is fed trunk first through the input opening and as the branches move through the slot openings. A floor standing bucking machine and a hingeably closeable bucking tractor attachments are disclosed.

### CROSS-REFERENCE TO RELATED APPLICATIONS

None.

### BACKGROUND OF THE INVENTION

The technical field of the invention pertains generally to plant bucking machines, and, more particularly, to designs and methods for whole plant bucking comprising stripping or pulling off leaves, flowers, and other plant material from stems and branches.

A bucking machine, or destemmer or debudder, or bucker, generally refers to a machine or device for removing plant material such as leaves, flowers, buds, and/or other plant material from the stems of the plant. Plants typically have a main stem with several branches stemming off of the main stem. Each of the separate branches (or individual stems) have leaves and plant material that need to be removed during processing. Existing processing methods require separating all of the branches and sub-branches into a collection of separate (individual) stems, each stem having leaves, buds, and/or other plant materials to be bucked, or removed, in a bucking process.

Existing automated buckers are floor-standing machines and involve feeding an individual stem (or individual branch), bottom-end first, into a hole sized for the particular diameter of stem, and pulling the stem through the hole so that the circumference of the hole strips off all the plant material from the stem as the stem is pulled through the hole. Rollers are typically used for pulling the stem through the hole. Different sized holes (or substantially circular openings) are used for different stem diameters. The plant material stripped from the stem falls from the front (or leading) face of the hole (opening), typically into a catch bin positioned immediately under the feed hole/opening.

Several designs exist. The Twister B4 Bucking Machine, Triminator Buckmaster Bucking Machine, Munch Machine Mother Bucker, EZTRIM DeBudder Stem Removal Machine, and TrimPro Bucker each use a front plate with different sized feed holes. The front plate is substantially planar (flat) with substantially circular feed holes ranging in diameter to permit feeding through stems up to ¾ inch. The EZTRIM machine has four to eight feed holes ranging from 5/32 inch to ½ inch diameter.

The Trimworkz Ultimate Bud Bucker Machine also uses a similar substantially planar front plate with multiple different sized feed holes. However, the Trimworkz machine includes several more feed holes than other devices—between fifteen and thirty feed holes—to provide increased processing capacity.

The Greenbridge Harvester Black Bear II bucker includes a single variable-sized entry (feed) hole that adjusts in its opening diameter to accommodate the stem diameter, opening up to a maximum diameter of ⅞ inch. The Greenbridge bucker processes individual stems, one stem at a time.

An example of a non-automated, manual bucking device is the DL Wholesale Debudder Bucket Lid, which consists of a planar (flat), semi-circular shaped apparatus that snaps onto a portion (segment) of the upper rim of a standard 5-gallon bucket. The device has slots of various sizes and shapes and is used by sliding an individual stem into an open end of a slot, then pulling the stem, bottom-end first, through the slot to strip the leaves and other plant material from the stem.

None of the existing bucking devices and methods are capable of bucking a whole plant without first separating the individual branches (for processing individual stems, one stem at a time or with one stem being fed through a particular hole at any given time). None of the existing devices and methods are suitable for outdoor, in-field use or use with existing agricultural/farming equipment. What is needed, therefore, are improvements for plant bucking that address shortcomings of the available designs and methods.

The foregoing and other objectives, features, and advantages of the invention will be more readily understood upon consideration of the following detailed description of the invention taken in conjunction with the accompanying drawings.

### BRIEF DESCRIPTION OF THE SEVERAL DRAWINGS

For a more complete understanding of the present invention, the drawings herein illustrate examples of the invention. The drawings, however, do not limit the scope of the invention. Similar references in the drawings indicate similar elements.

FIG. 1 illustrates a bottom view of a whole plant bucker, according to preferred embodiments.

FIG. 2 illustrates a side view of the whole plant bucker shown in FIG. 1.

FIG. 3 illustrates a perspective view of a floor-standing whole plant bucking machine, according to preferred embodiments.

FIG. 4 illustrates a top view of a hinged whole plant bucker, according to preferred embodiments.

FIG. 5 illustrates a side cut view of the hinged whole plant bucker shown in FIG. 4.

FIG. 6 illustrates a top view of a whole plant bucker formed from a rectangular sheet with a single fold, according to some embodiments.

FIG. 7 illustrates a side view of the whole plant bucker shown in FIG. 6.

FIG. 8 illustrates an end view of the whole plant bucker shown in FIG. 6 and as indicated in FIG. 7.

FIG. 9 illustrates a top view of a cone shaped whole plant bucker, according to preferred embodiments.

FIG. 10 illustrates a side view of the cone shaped whole plant bucker shown in FIG. 9.

FIG. 11 illustrates a top view of a square pyramid shaped whole plant bucker, according to preferred embodiments.

FIG. 12 illustrates a side view of the square pyramid shaped whole plant bucker shown in FIG. 11.

FIG. 13 illustrates a bottom view of a hexagonal shaped whole plant bucker with a different slot pattern than the whole plant bucker shown in FIG. 1, according to some embodiments.

FIG. 14 illustrates a bottom view of a hexagonal shaped whole plant bucker with different (rounded) slot openings than the whole plant bucker shown in FIG. 1, according to some embodiments.

FIG. 15 illustrates a top view of a hexagonal shaped whole plant bucker, according to preferred embodiments.

### DESCRIPTION OF PREFERRED EMBODIMENTS

In the following detailed description, numerous specific details are set forth in order to provide a thorough understanding of the preferred embodiments. However, those skilled in the art will understand that the present invention may be practiced without these specific details, that the present invention is not limited to the depicted embodiments, and that the present invention may be practiced in a variety of alternate embodiments. In other instances, well known methods, procedures, components, and systems have not been described in detail.

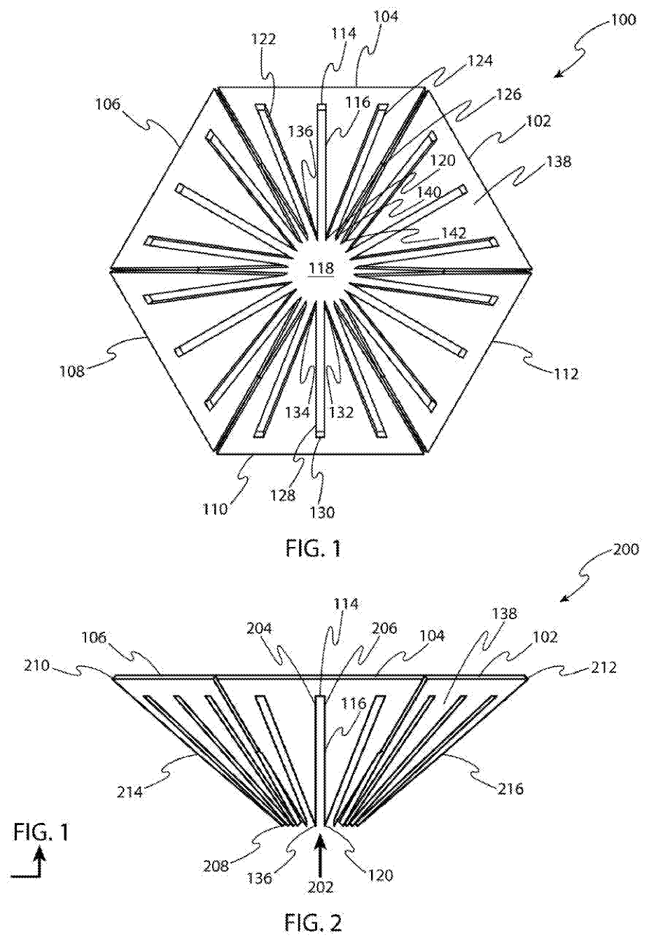

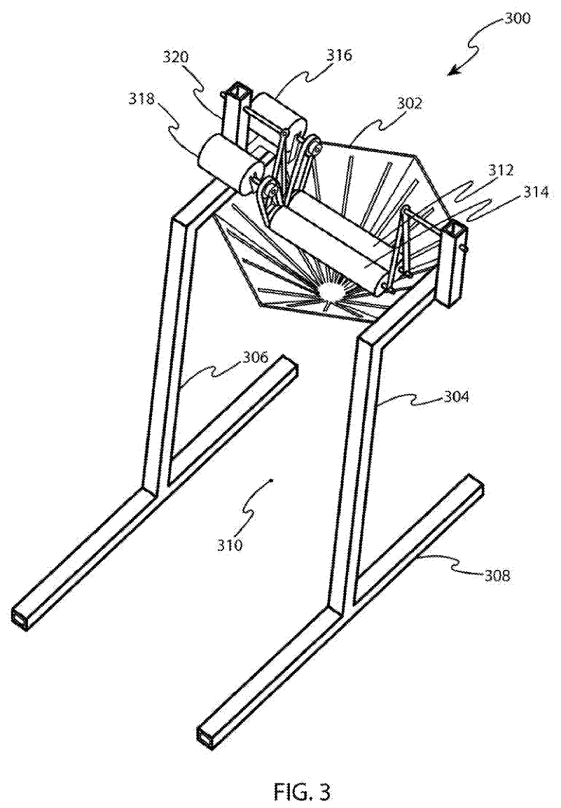

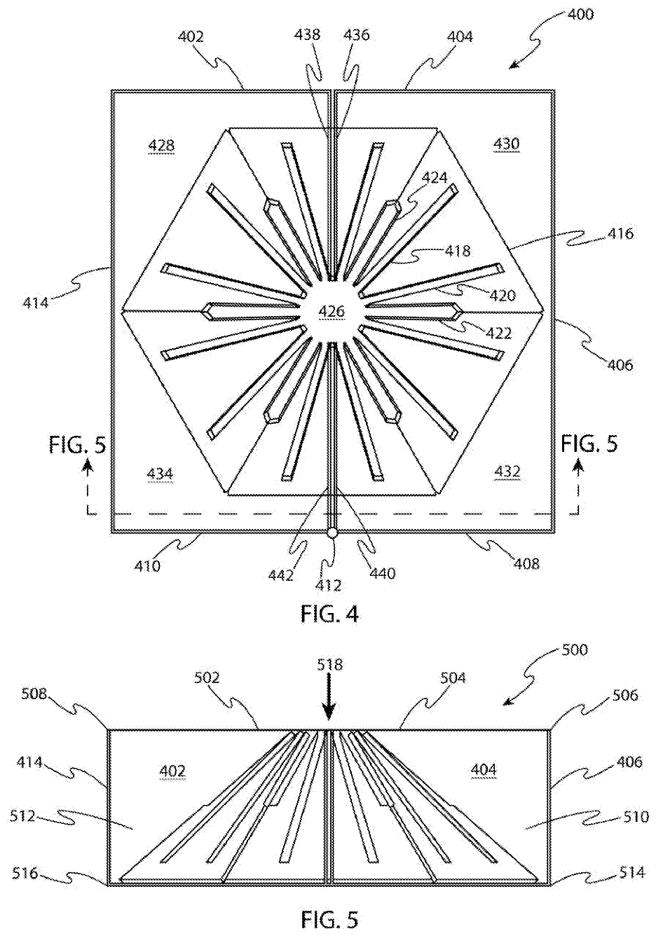

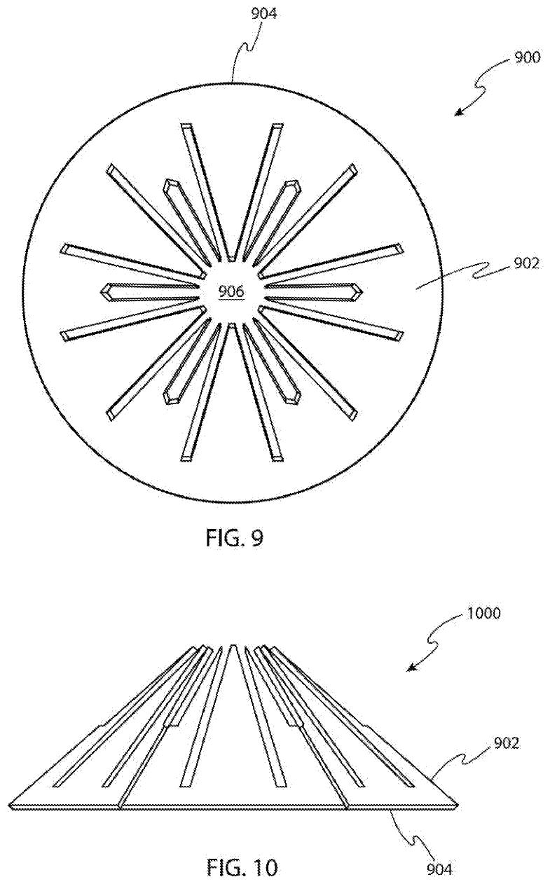

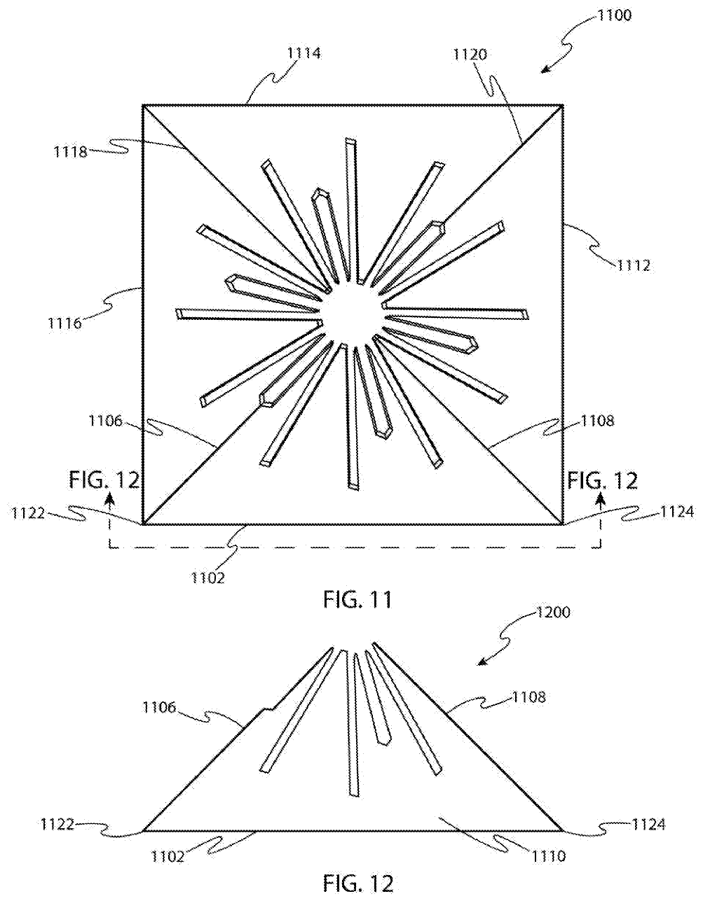

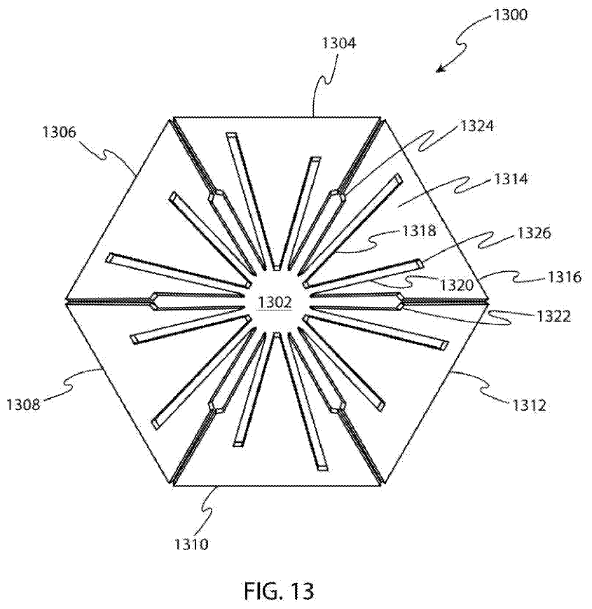

As an overview, FIGS. 1-2 show bottom and side views of a whole plant bucker, with the stripping (or bucking) member comprising a hexagonal pyramid having a plurality of radially directed, centrally converging slots that catch and pull off leaves and other plant material as the main stem is pulled or fed through the smaller, pointed end of the bucking member. As the whole plant is fed bottom-end first/main stem first into the small end of the pyramid shaped bucker, individual branches are caught within the individual slots, and the angle/pyramid shape causes the branches to open radially away from the main stem. FIG. 3 shows a floor standing unit comprising a whole plant bucker. FIGS. 4-5 show a hinged whole plant bucker that may be affixed and operated, for example, as an attachment to a tractor or other farm implement. The hinged whole plant bucker may be hingeably closed around the main stem of a (for example, potted or in-ground) plant (with the small or pointed end of the pyramid shaped bucking member oriented upward) and then pulled upward over the plant to strip the plant material from all of the plant's branches at once. FIGS. 6-8 show a single-fold, rectangular whole plant bucker. FIGS. 9-10 show a cone shaped whole plant bucker. FIGS. 11-12 show a square pyramid shaped whole plant bucker. And FIGS. 13-15 show additional variations of the hexagonal pyramid shaped whole plant bucker illustrated in FIG. 1.

Although preferred embodiments are presented and described in the context of variations of a whole plant bucker substantially as shown in FIGS. 1-15, numerous other variations may be used. For example, different numbers of slots may be used. Different shaped slots may be used. The angle from the base of the pyramid or cone shaped bucking member, for example, may be more or less than shown in the variations shown described herein. The bucking member may be used in an orientation other than as shown. For instance, instead of the small end downward (in FIG. 3) or small end upward (as described with regard to the hinged bucker shown in FIG. 4), the bucking member may be used, in less preferred embodiments, at any angle and with either the plant being pulled or pushed through the bucking member or the bucking member being moved in relation to the plant.

FIG. 1 illustrates a bottom view of a whole plant bucker 100, according to preferred embodiments. The bucker 100, as shown, comprises six hexagonal sections such as section 138 to form a hexagonal shaped pyramid having (lower edge) sides (or base edges) 102, 104, 106, 108, 110, and 112. The bucker 100 is preferably symmetrical and comprises equally sized sections that assemble together to form a three dimensional stripping or bucking member. However, in less preferred embodiments (not shown) the stripping member need not be regular shaped, with sides of equal size, or symmetrical. The stripping member preferably includes a plurality of slots such as slots 122, 116, 124, 128 that converge to a central opening 118 sized to receive a bottom end of the main stem of a plant. As the bottom end of the main stem (or trunk end of the plant) is fed into the central (center) opening 118, individual branches (or sub-stems, or stems) are caught and led into slot openings. And as the whole plant is drawn through the bucker 100 and branches are drawn through the slots, the plant material such as leaves, flowers, buds, or other plant material on each branch (stem) is stripped off. For example, one or more branch or stem may be caught by the opening to slot 124 formed by opening points 120 and 140. Another branch or stem (or more than one) may be caught by the opening points 120 and 136 that lead into the slot 116 adjacent to slot 124. Similarly, as the plant moves through the bucking member all of the individual branches (stems), as the present inventor discovered, will be caught and consequently fed through the slots of the bucking member.

As shown, the hexagonal bucking member comprises six sections, each section having three slots within the main hexagonal surface area (such as the surface area for the hexagonal section 138) and slots at each edge of the hexagonal section. For example, both (radial) edges of the hexagonal section 138 (having base edge 102) comprises a slot such as the slot shown having central opening points 140 and 142 and an outward end (or slot end) 126. Each of the hexagonal sections is preferably the same so as to reduce complexity in manufacturing the bucking member. For instance, the sections having base edges 104 and 110 both have the same dimensions and slot configurations. As shown, slot 116 in the section with base edge 104 has a length 114-136 from a slot end 114 to its opening points 136 and 120, and slot 128 in the section with base edge 110 has a length 130-134 from its slot end 130 to its opening points 134 and 132; base edges 104 and 110 are the same length, and slot lengths 114-136 and 130-134 are the same Likewise, the other slots in each section are sized and dimensioned the same as respective slots and dimensions in the other sections of the pyramidally shaped bucking member. As mentioned and repeated hereinafter, the bucking member need not be comprised of six hexagonal, or any particular number of, sections, or any separable/individual sections at all, and may comprise any number of (more than one) slots each of which has an open end and a closed end and converges to a central opening 118 that connects the open region of each slot. In preferred embodiments, the bucking member comprises three or more slot openings that converge to one opening.

The bucking member 100 may comprise, in less preferred embodiments, a substantially flat plate (not shown). Or, the bucking member comprise, in less preferred embodiments, a tubular-shaped member having slots extending from one (the central/feed opening) end toward the other end (not shown). However, the present inventor discovered that a pyramid or cone shaped bucking member improves the efficiency of stripping of plant material by allowing the branches to open up as the whole plant is fed through the bucking member (or as the bucking member is drawn over the whole plant). As the main stem passes through the central opening 118, the branches are caught by the slot openings; and, as shown in FIG. 2, an angle of sides 216, 214 relative to the base 212-210 helps open up the branches and improve the efficiency of stripping plant material from each branch/stem as the plant moves through the bucking member. For example, FIG. 2 illustrates a side view 200 of the whole plant bucker 100 shown in FIG. 1, and slot 116 is oriented at an angle (i.e. as shown, the angle of side 216 in relation to the base edges 106, 104, 102 shown extending across a base width 212-210). As a whole plant is fed 202 bottom end/main stem first into the (smaller) central open end 118 of the bucking member 100, one or more branch may become caught by the slot opening points 136 and 120, and thereafter move into the slot 116. The branch may move within the slot 116 to any position between the opening/opening points 136, 120 and the slot end 114. As the branch moves through the slot 116, the plant material is stripped off of the branch (or sub-stem, or stem) by the edges 204, 206 and/or end 114 of the slot.

The present inventor discovered the angle of the sides (such as sides 216, 210) of the bucking member 100 are preferably substantially proportionately as shown in FIG. 2. The angle, for example, of side 214 may be around 45 degrees. That is, the side 214 having length 208-210 between the central opening 118 (at slot opening point 208) and base edge 106 at reference point 210 may be approximately 45 degrees from the base edge 106 and the base width between reference points 210 and 212. Put another way, the angle of side 214 may be defined as the angle between the base edge 106 (shown horizontal in FIG. 2) (or a plane defined by the base edges) and side 214. Alternatively, the angle of side 214 may be defined as the angle in degrees between side 214 and a reference that is normal (perpendicular) to the (feed) input direction 202. In preferred embodiments, the angle of sides 216, 214 is between 15 and 75 degrees. The angle is preferably greater to or equal to zero degrees and less than or equal to ninety (90) degrees. The smaller the angle (or flatter the bucking member 100), the less the branches may open up as the whole plant is fed through the bucker. The larger the angle (or taller the bucking member 100 in a vertical distance between the opening 118 (at references 208, for example) and the base edges (along the base width 208-210, for example)), the more the branches may open up and move along the slots toward the slot ends. An angle of zero degrees (between side 214 and the base plane) may comprise a substantially flat bucking member, for example, perpendicular to the feed direction 202 into the central opening 118. An angle of 90 degrees (between side 214 and the base plane) may comprise a substantially tube-shaped bucking member, for example, parallel to the feed direction 202 into the central opening 118.

The opening 118 defined by the convergence area of the bucking member slots is herein referred to as the “smaller opening” (or small or input opening) of the bucking member. A “larger opening” (or large or exit opening) of the bucking member, in the context of a side view of the bucking member, as in FIG. 2, is defined by the base edges between 210 and 212. As a whole plant is fed 202 into the smaller opening 118 of the bucking member, the branches (sub-stem) and main stem material travels from the opening 118 and out of the larger opening 210-208 of the bucking member. The opening 118 has a smaller diameter than the larger opening defined by the base edges 102, 104, 106, 108, 110, 112.

In some embodiments, the bucking member 100 is oriented as shown in FIG. 2, with its smaller (central) opening 118 downward and the base of the bucking member oriented upward. In such orientation, plant material stripped from the branches and stems will fall downward as the branches and stems are pulled upward through the bucking member. Dimensions of the opening 118 may vary. The opening 118 is preferably adapted so as to permit feeding through larger diameter main stemmed plants, with the slots having a width between sides 204 and 206, for example, sized to strip plant material from stems/branches having a diameter ranging from 5/32 inch to ¾ inch. More preferably, each of the slots comprises an opening width 204-206 range from approximately ¼ inch to 0.38 inch, with slot lengths 136-114 ranging from 6 to 9 inches. The central opening 118, in preferred embodiments, has a diameter of approximately 2.6 inches. The base width 210-212 is preferably approximately 17.68 inches. And the vertical height between the opening 118 at reference 208 to the base having width 210-212 is preferably approximately 6.38 inches. These are exemplary dimensions for preferred embodiments of a bucking member 100. Other dimensions may be used in less preferred embodiments.

Next, FIG. 3 illustrates a perspective view of a floor-standing whole plant bucking machine 300, according to preferred embodiments. The floor-standing machine 300, as shown, preferably comprises a bucking member such as the pyramid-shaped stripper/bucker member 100. Tubular metal vertical support members 304 and leg members 306, 308 preferably hold the bucking member 302 vertically over a floor area 310. Vertical extensions 320 may be used to position rollers 312, 314 within the larger opening of the bucking member 302. The rollers 312, 314 may be rotated using belts and motors 316, 318. The rollers engage with main stem and branches fed upward (or pulled upward) through the small end/center opening of the bucking member 302. As the whole plant is fed bottom-end first through the center opening of the bucking member, branches are caught in the slots and plant material is stripped away. The stripped plant material then falls downward into (not shown) a bin or other catch positioned below the bucking member 302.

Various alternative methods and mechanisms (not shown) may be used to introduce and move through the whole plant bucking member. The bucking machine 300 as shown in FIG. 3 includes a pair of rollers 312, 314 oriented behind the small end/central opening of the bucking member so that as the main stem of the plant is fed into the central opening it may be caught by the rollers and thereafter pulled through the bucking member. The rollers may be substantially proportioned and positioned as shown in FIG. 3 in preferred embodiments. In other embodiments the rollers may be proportioned differently and/or positioned differently, or not used at all. The whole plant may be pulled through the bucking member manually by hand or automatically using means different than shown. For instance, the bottom end of a stem or branch or whole plant main stem (with multiple branches stemming therefrom) may be fed through the bucking member whereby a string or semi-rigid member (such as a zip tie or the like) or length of rigid rod or strap material that is affixed to the bottom end of main stem and then used to pull (move) the plant through the bucking member.

In another application, a whole plant bucking member may be integrated into a hinged apparatus that can be hingeably closed around the main stem of a whole plant and then moved in relation to the plant to strip off plant material. For example, FIG. 4 illustrates a top view of a hinged whole plant bucker 400, according to preferred embodiments, and FIG. 5 illustrates a side cut view 500 of the hinged whole plant bucker 400 shown in FIG. 4. As shown, a hexagonal pyramid shaped bucking member, having, for example, base edges such as hexagonal base edge 416, may comprise two hingeably openable halves. A hinge 412 connects the two halves, and each half comprises half of the bucking member with sides walls and bottom surfaces for catching and holding plant material that has been stripped from the whole plant. One half (shown on the right) preferably comprises side walls 436, 404, 406, 408, and 440, and bottom surfaces 430 and 432; and the other half (shown on the left) likewise preferably comprises side walls 438, 402, 414, 410, and 442, and bottom surfaces 428 and 434. The two halves are hingeably openable about hinge 412 to allow for the main stem of a whole plant to be positioned within the central opening 426 of the (two halves of the) bucking member.

In operation, the hinged bucker 400 may be closed around the main stem (or trunk) of a (potted or in-ground planted) whole plant, using closing mechanisms and structures (not shown) of a tractor or other farm implement, and then moved up and over the plant so that the main stem and branches are effectively fed 518 through the small end of the bucking member. As the bucker 400 is moved upward, branches become captured within slots of the bucking member, such as slots 424, 418, and 420, and the leaves, flowers, and other plant material is stripped from the branches and retained within areas (such as volumes/areas 510 and 512) defined by the side walls. The side walls may of different heights, shapes, and dimensions than shown. However, the present inventor discovered using side walls that are approximately the same vertical height as the (side view) of the bucking member is preferred. As shown, side walls 402 and 404 have top edges 502 and 504, respectively; and side walls 414 and 406 have top edges 508 and 506, respectively. The height of the side walls 414 and 406, for example, are preferably 516-508 and 514-506, respectively.

The bucking member used may comprise differently shaped, dimensioned, and proportioned structures. The bucking members shown and illustrated herein comprise substantially flat material such as sheet metal or sheet plastic or the like that is formed into a three dimensional shape having a width and length sized appropriately to include a plurality of slot openings that converge into a central opening sized to accept the main stem of a whole plant, and a height between the central opening of the bucking member and base edges of the bucking member that are positioned away (outward) from the central opening. The slots may be of different lengths and shapes, and the slots need not be substantially radially straight as shown herein. That is, the slots may comprise “S” shaped slots or any shape. The number and pattern of the slots may vary. The slot pattern need not be symmetrical. The overall shape of the bucking member need not be hexagonal (in a top view) or pyramidal (in perspective and orthogonal views).

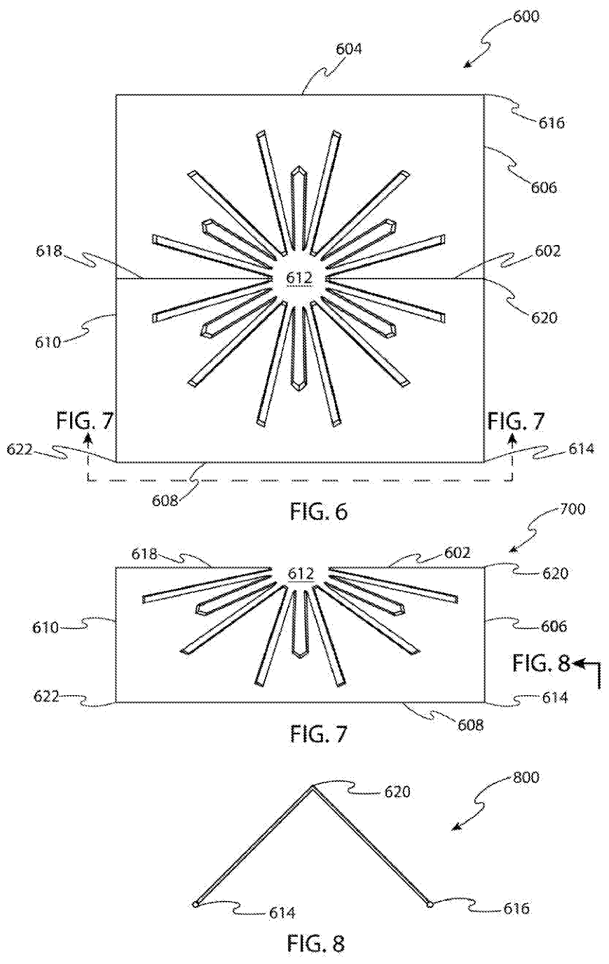

Exemplary alternative shapes and configurations of a whole plant bucking member are illustrated in FIGS. 6-15, according to various embodiments. For example, FIG. 6 illustrates a top view (looking into the small end/central opening 612) of a whole plant bucker 600 formed from a rectangular sheet (having sides 604, 606, 608, and 610) with a single lengthwise fold 602/618 (fold 602 on one side of the opening 612, and fold 618 on the other side of opening 612), according to some embodiments. As shown, the bucking member 600 comprises a substantially rectangular sheet having a length 622-614 (shown on side and base edge 608) and a (folded, top view) width 614-616 (shown on side 606), which is folded (folds 602 and 618) to create a height 614-620 between lower base edges 608 and 604 and the fold(s) 602/618 (and central opening 612 where the plurality of slots/slot openings converge). The width dimension of the unfolded sheet material of the bucking member 600 is greater than shown, due to the fold 602/618. The illustrations in FIGS. 6-8 may not be entirely proportionate to one another; and it is easily understood that FIGS. 6-8 are intended to depict related views—FIG. 6 depicts a top view of the bucking member 600, FIG. 7 illustrates a side view 700 of the whole plant bucker 600 shown in FIG. 6, and FIG. 8 illustrates an end view 800 of the whole plant bucker 600 shown in FIG. 6 and as indicated in FIG. 7.

The bucking member 600 may comprise a lower cost and simpler bucking member insofar as a single rectangular sheet may be used, with a plurality of slot openings formed or cut into the sheet that converge to a central opening 612 sized for receiving the main stem of a whole plant, with the slot openings extending outward from the central opening 612 oriented and arranged so as to catch branches of the plant as the plant moves through the bucking member, the sides and ends of the slots stripping the plant material from each of the branches. The bucking member 600 may be used with a floor standing machine 300. The bucking member 600 may be used in a hinged whole plant bucker as in FIG. 4. In a hinged whole plant bucker, an embodiment may comprise a bucking member 600 that is (not shown) hingeably openable about the fold line 602/618 and having (not shown) side walls extending from base edges and sides 608, 604, 608, 610 up to the height 620 of the fold line 602/618 (the side walls functioning as described for the hinged bucker 400).

A cone shaped bucking member 900 is shown in FIGS. 9 and 10. FIG. 9 illustrates a top view of a cone shaped whole plant bucker 90, according to preferred embodiments, and FIG. 10 illustrates a side view 1000 of the cone shaped whole plant bucker 900. As shown, the cone shaped bucking member comprises a cone surface 902, a substantially circular base 904, and a plurality of slot openings within the cone surface 902 that converge to a central opening 906 at the small end/central opening at the vertex or height of the cone shape. The bucking member 900 may be used in a bucking machine as shown in FIG. 3 or, with a diameter parting line, in a hinged bucker as illustrated in FIG. 4 (and also described with respect to a single-fold bucking member 600).

Next, FIGS. 11 and 12 illustrate top and side views, respectively, of a square pyramid shaped whole plant bucking member 1100, according to preferred embodiments. As shown, the bucking member 1100 comprises a square pyramid having base edges 1114, 1112, 1110, and 1116 (each base edge having a length 1122-1124), an apex of the pyramid comprising a central opening 1104 where a plurality of slot openings converge, and lateral edges 1108, 1120, 1118, and 1106. The bucking member 1100 has a (vertical) height that extends from the base edges, such as base edge 1102, to the apex/central opening 1104; and the bucking member comprises four faces such as face 1110. The side view 1200 in FIG. 12 depicts face 1110, and in preferred embodiments each of the four faces comprising the bucking member 1100 are the same as in FIG. 12 or a mirror image therefor. For example, the bucking member 1100 includes a pair of identically formed faces for the faces with base edges 1102 and 1114, and a pair of identically formed faces for the faces with base edges 1112 and 116, with each pair being the mirror image of the other. In this way, complexity is reduced by allowing the pyramid shaped bucking member to be constructed from four sections formed as shown in FIG. 12.

As with the exemplary bucking members in FIGS. 6-10, the bucking member 1100 may be used in a bucking machine as shown in FIG. 3 or, with a suitably convenient parting line (such as along lateral edges 1118 and 1108, in a hinged bucker as illustrated in FIG. 4 (and also described with respect to a single-fold bucking member 600 and a cone shaped bucking member 900).

As previously indicated, FIGS. 13-15 show additional variations of the hexagonal pyramid shaped whole plant bucker illustrated in FIG. 1. For example, FIG. 13 illustrates a bottom view (looking through the small end/central opening 1302) of a hexagonal shaped whole plant bucker 1300 with a different slot pattern than the whole plant bucker shown in FIG. 1, according to some embodiments. As in the hexagonal bucking member in FIG. 1, the bucking member 1300 comprises six hexagonal sections (with base edges 1304, 1306, 1308, 1310, 1312, and 1316), each with a face such as face 1314 having base edge 1316, and a plurality of slots which converge at the central opening 1302. Slots (or slot openings) 1324, 1318, and 1320 are each of different lengths from one another. Each of the hexagonal sections effectively includes three slot openings (two slots such as slots 1318 and 1320, plus half portions of slots 1324 and 1322 that are formed at the lateral edges of each hexagonal section). Each of the hexagonal sections need not be the same or similar. However, the present inventor discovered reduced complexity and cost of manufacture is achieved when each section of the bucking member (whether hexagonal pyramid, square pyramid, single-fold, etc.) is the same as (or a mirror image of) each adjacent section. As previously indicated, the slot openings may be of different shapes. For instance, slots 1324 and 1328 as shown in FIG. 13 are each of substantially constant (slot opening) width whereas, in less preferred embodiments, the slot opening width may increase as the slot extends away from central opening 1302. This is in contrast to, for example, the slot opening having opening points 140 and 142 that narrows in width as the opening extends outward away from central opening 118 in the bucking member 100 illustrated in FIG. 1. The bucking member 1300 is illustrated in FIG. 13 as having 18 slot openings, whereas the bucking member 100 in FIG. 1 is illustrated having 24 slot openings.

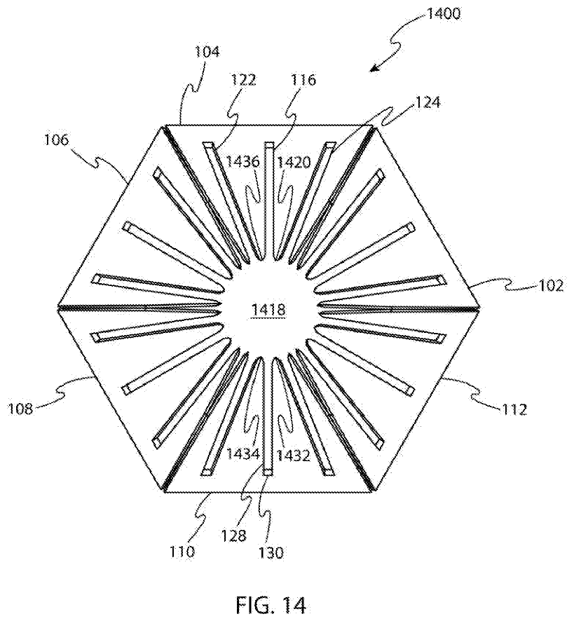

FIG. 14 illustrates a bottom view of a hexagonal shaped whole plant bucker 1400 with different (rounded) slot openings than the whole plant bucker shown in FIG. 1, according to some embodiments. As shown in FIG. 14, the bucking member 1400 is essentially the same except with rounded slot opening points, such as, for example, slot opening points 1436, 1420, 1432, and 1434 so that all the slot openings converging into the central opening 1418 comprise rounded off slot opening points.

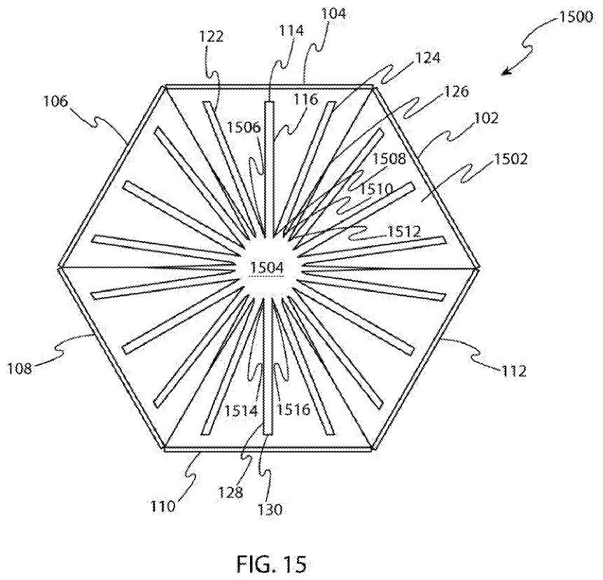

FIG. 15 illustrates a top view (looking through the larger end, from the base of the hexagonal pyramid toward the small end/central opening 1504) of a hexagonal shaped whole plant bucker 1500, according to preferred embodiments. The bucking member 1500 is intended to be essentially the same as the bucking member in FIG. 1 except the slot openings converge to a central opening 1504 that is hexagonal shaped, with the slot opening points, such as slot opening points 1506, 1508, 1510, 1512, 1514, and 1516 formed to be substantially parallel with their corresponding base edges. For example, slot opening points 1506, 1508, and 1510 are the same distance from base edge 104. Each of the hexagonal faces, such as face 1502, is preferably identical to the adjacent hexagonal faces.

The whole plant buckers described in FIGS. 1-15 preferably comprise a three-dimensional cylindrical pyramid or cone shaped bucking member with a plurality of, or three or more, or multiple slot openings that converge to an opening at the vertex/apex/smaller end of the bucking member structure. As described, the bucking member may comprise a variety of three-dimensional shapes, including, for example, a base that is round, three sided, four sided, five sided, six sided, etc. and an overall shape that is a hexagonal pyramid, cone, square pyramid, etc.

According to preferred embodiments, a whole plant bucker comprises: a bucking member having a length and a width defining a base plane, and a height normal to said base plane; sides of the bucking member extending from said base plane to said height; a plurality of slot openings formed within said sides of said bucking member such that the slot openings converge to an input opening; and an angle between said sides and said base plane that is greater than zero, said input opening sized to receive a trunk of a whole plant, and said slot openings sized to receive branches of said whole plant and strip plant material from said branches as said whole plant is fed trunk first through said input opening in a direction toward said base plane and as said branches move through said slot openings in a direction toward said base plane.

When the trunk end of a whole plant is pulled or pushed through the small (input) opening of the bucking member, the branches following the trunk (or main stem) slide into the various slots/slot openings in the bucking member. When the plant is pulled or pushed completely through the bucking member, branches and stem (trunk) material emerge from the larger end/large opening (at the base end) of the bucking member while plant material stripped from the branches, such as leaves and flowers/buds, remains on the input side, thus separating the leaves, flowers/buds, and other plant material from skeleton (intact trunk and branches) of the plant.

The present inventor discovered a whole plant bucker as described herein greatly improves the speed at which leaves and buds/flowers are separated from the plant stems as compared to existing bucking machines and methods which require pre-processing the plant to separate each of the separate branches, then bucking each branch (or stem) one at a time. In contrast, the whole plant bucker described herein accommodates processing of all branches (that is, the whole plant) at once, avoiding the labor and time to break individual branches off and, for example, individually inserting each stem through passing them through a particular appropriately sized hole (as required when using existing bucking machines).

Further, the present inventor discovered the whole plant bucking members described herein may be adapted for use in floor standing whole plant bucking machines (as in FIG. 3) or adapted for use in an attachment (as in FIG. 4) to a tractor or other in-field type farm implement, preferably using hydraulics or other powered mechanisms for handling the bucking member and collected the plant material bucked from the plant, effectively bucking the entire plant at one time.

The terms and expressions which have been employed in the foregoing specification are used therein as terms of description and not of limitation, and there is no intention in the use of such terms and expressions of excluding equivalents of the features shown and described or portions thereof, it being recognized that the scope of the invention is defined and limited only by the claims which follow.

What is claimed is:

1. A whole plant bucker comprising:
a bucking member having a length and a width defining a base plane, and a height normal to said base plane;
sides of the bucking member extending from said base plane to said height;
a plurality of slot openings formed within said sides of said bucking member such that the slot openings converge to an input opening; and
an angle between said sides and said base plane that is greater than or equal to zero and less than or equal to 90 degrees,
said input opening sized to receive a trunk of a whole plant, and
said slot openings sized to receive branches of said whole plant and strip plant material from said branches as said whole plant is fed trunk first through said input opening in a direction toward said base plane and as said branches move through said slot openings in a direction toward said base plane.

2. The whole plant bucker of claim 1, wherein said angle is approximately within a range of 15 to 75 degrees.

3. The whole plant bucker of claim 1, wherein said angle is approximately 45 degrees.

4. The whole plant bucker of claim 1, wherein said bucking member includes more than three of said slot openings.

5. The whole plant bucker of claim 1, further comprising:
floor standing structure adapted to support said bucking member at a predetermined height above a floor or ground surface; and
a pair of rollers adapted for capturing and pulling said trunk of said whole plant in a direction from said input opening and toward said base plane so that said branches of said whole plant are received into said slot openings of said bucking member.

6. The whole plant bucker of claim 1, further comprising:
a hinge affixed to hingeably openable and closeable portions of said bucking member and configured to permit said bucking member to be hingeably opened to position said trunk of a whole plant within said input opening, and then hingeably closed about said trunk so as to capture said trunk within said input opening; and
side walls extending upward from base plane surfaces in a direction substantially normal to said base plane, said side walls sized and oriented so as to catch plant material stripped from said branches as said branches move through said slot openings in said direction toward said base plane.

7. The whole plant bucker of claim 1, wherein said base plane comprises base edges forming a hexagon, and said bucking member comprises a hexagonal pyramid with said plurality of slot openings converging at said input opening at a small end or top of said hexagonal pyramid.

8. The whole plant bucker of claim 1, wherein said base plane comprises base edges of a rectangular sheet having a single-fold such that said slot openings converge at said input opening positioned along said single-fold, the single-fold establishing said height of said bucking member.

9. The whole plant bucker of claim 1, wherein said base plane comprises base edges forming a square, and said bucking member comprises a square pyramid with said plurality of slot openings converging at said input opening at a small end or top of said square pyramid.

10. The whole plant bucker of claim 1, wherein said base plane comprises base edges forming a circle, and said bucking member comprises a cone with said plurality of slot openings converging at said input opening at a small end or top of said cone.

11. A method of bucking a whole plant, comprising:
providing a whole plant bucker as claimed in claim 1;
moving said whole plant or moving said bucking member such that said whole plant moves through said input opening trunk first and in a direction toward said base plane of said bucking member; and
collecting plant material stripped from said branches of said whole plant.

12. The method of claim 11, wherein said angle is approximately within a range of 15 to 75 degrees.

13. The method of claim 11, wherein said angle is approximately 45 degrees.

14. The method of claim 11, wherein said bucking member includes more than three of said slot openings.

15. The method of claim 11, wherein said bucking member further comprises:
floor standing structure adapted to support said bucking member at a predetermined height above a floor or ground surface; and
a pair of rollers adapted for capturing and pulling said trunk of said whole plant in a direction from said input opening and toward said base plane so that said branches of said whole plant are received into said slot openings of said bucking member.

16. The method of claim 11, wherein said bucking member further comprises:
a hinge affixed to hingeably openable and closeable portions of said bucking member and configured to permit said bucking member to be hingeably opened to position said trunk of a whole plant within said input opening, and then hingeably closed about said trunk so as to capture said trunk within said input opening; and
side walls extending upward from base plane surfaces in a direction substantially normal to said base plane, said side walls sized and oriented so as to catch plant material stripped from said branches as said branches move through said slot openings in said direction toward said base plane.

17. The method of claim 11, wherein said base plane comprises base edges forming a hexagon, and said bucking member comprises a hexagonal pyramid with said plurality of slot openings converging at said input opening at a small end or top of said hexagonal pyramid.

18. The method of claim 11, wherein said base plane comprises base edges of a rectangular sheet having a single-fold such that said slot openings converge at said input opening positioned along said single-fold, the single-fold establishing said height of said bucking member.

19. The method of claim 11, wherein said base plane comprises base edges forming a square, and said bucking member comprises a square pyramid with said plurality of slot openings converging at said input opening at a small end or top of said square pyramid.

20. The method of claim 11, wherein said base plane comprises base edges forming a circle, and said bucking member comprises a cone with said plurality of slot openings converging at said input opening at a small end or top of said cone.
